(19) United States
(12) Patent Application Publication
(10) Pub. No.: US 2017/0212824 A1
(43) Pub. Date: Jul. 27, 2017

(54) DYNAMIC TUNING OF A SIMULTANEOUS MULTITHREADING METERING ARCHITECTURE

(71) Applicant: International Business Machines Corporation, Armonk, NY (US)

(72) Inventors: EMRAH ACAR, Montvale, NJ (US); JANE H. BARTIK, Poughkeepsie, NY (US); ALPER BUYUKTOSUNOGLU, White Plains, NY (US); BRIAN R. PRASKY, Campbell Hall, NY (US); VIJAYALAKSHMI SRINIVASAN, New York, NY (US); JOHN-DAVID WELLMAN, Hopewell Junction, NY (US)

(21) Appl. No.: 15/003,205

(22) Filed: Jan. 21, 2016

(51) Int. Cl. G06F 11/34; G06F 9/30; G06F 11/30

(52) U.S. Cl. CPC G06F 11/3447; G06F 11/3017; G06F 9/3009; G06F 11/3024; G06F 11/3428

(57) ABSTRACT

The disclosed herein relates to a method of dynamic simultaneous multithreading metering for a plurality of independent threads being multithreaded. The method is executable by a processor. The method includes collecting attributes from processor and building a model utilizing the attributes. The method also includes performing the dynamic simultaneous multithreading metering in accordance with the model to output metering estimates for a first thread of the plurality of independent threads being multithreaded and updating the model based on the metering estimates.

### BACKGROUND

The disclosure relates generally to dynamic tuning of a simultaneous multithreading metering architecture.

In general, programmable aspects of contemporary implementations of simultaneous multithreading metering architecture are fixed and are not changed during a program run time. For example, the programmable aspects rely on a static post-silicon measurement-based calibration methodology. This methodology utilizes sample points that are collected for a series of targeted benchmarks, such that all the simultaneous multithreading metering events are represented. Each sample point contains a single thread performance measurement, a count for each simultaneous multithreading metering counter event, and simultaneous multithreading performance measurement. Once the data is gathered and post-processed, an algorithm is run to determine all the simultaneous multithreading metering settings. The algorithm finds a global unique formula with the available hardware to calculate a best least-squares type curve fit for all the possible linear equations that can be formed with the available hardware.

### SUMMARY

According to one embodiment, a method of dynamic simultaneous multithreading metering for a plurality of independent threads being multithreaded is provided. The method is executable by a processor. The method includes collecting attributes from processor and building a model utilizing the attributes. The method also includes performing the dynamic simultaneous multithreading metering in accordance with the model to output metering estimates for a first thread of the plurality of independent threads being multithreaded and updating the model based on the metering estimates. The method can be embodied in a system and/or a computer program product.

Additional features and advantages are realized through the techniques of the embodiments herein. Other embodiments and aspects thereof are described in detail herein and are considered a part of the claims. For a better understanding of the embodiments herein with the advantages and the features, refer to the description and to the drawings.

### BRIEF DESCRIPTION OF THE SEVERAL VIEWS OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 illustrates a system comprising firmware for performing dynamic simultaneous multithreading metering in accordance with an embodiment;

FIG. 2 illustrates a process flow for performing dynamic simultaneous multithreading metering in accordance with an embodiment;

FIG. 3 illustrates another process flow for performing dynamic simultaneous multithreading metering in accordance with an embodiment;

FIG. 4 illustrates a schematic flow of model blending in accordance with an embodiment;

FIG. 5 illustrates another schematic flow of model blending in accordance with an embodiment;

FIG. 6 illustrates a schematic flow of dynamic simultaneous multithreading metering adjustments in accordance with an embodiment;

FIG. 7 illustrates another process flow for performing dynamic simultaneous multithreading metering in accordance with an embodiment; and

FIG. 8 illustrates a processing system in accordance with an embodiment.

### DETAILED DESCRIPTION

In view of the above, embodiments disclosed herein may include a system, method, and/or computer program product (herein the system) that implements a dynamic simultaneous multithreading metering architecture.

Simultaneous multithreading (SMT) generally is a technique for improving an overall efficiency of superscalar central processing units with hardware multithreading. Particularly, SMT permits multiple independent threads executed on the same micro architecture of the system (also referred to as processor architecture). A micro architecture can include front-end, dispatch, decode, and/or execution hardware/firmware. The goal of SMT is to allow the multiple independent threads to share components of the micro architecture to better utilize resources provided by the system. SMT thus allows for higher total throughput of a processor at the expense of individual thread performance. For instance, each single thread performance of the multiple independent threads is degraded while the system performance is improved (i.e., a higher total amount of work is done in a given amount of time).

SMT metering enables control and accounting of the multiple independent threads (so as to predict a single performance of any thread). For example, a customer who normally executes software in a single thread mode of a system of a provider will generally know the corresponding cost to execute that software. When the provider executes that same software as part of SMT, then the independent thread of that same software will have a different execution (a degraded performance) in view of the other independent threads running under SMT. SMT metering is utilized by the system to predict with a high accuracy the resources used by the independent thread of that same software, so that the corresponding cost of executing that same software under SMT can be reasonably accounted.

In general, the dynamic SMT metering architecture of the system includes building a predictive model for single thread, clustering of training data, building a multitude of multi-regional models, and blending multi-regional models to improve accuracy and model coverage. A model is a computer-based program or software designed to simulate processing resources of a thread and/or multiple threads. In operation, the system can blend multiple predictors to achieve a high-level of accuracy, task categories and correct sampling to build better training data, and implement a weighting based on distance to cluster-centroids, which yields an adaptive, reactive SMT metering function. The weights themselves can be adjusted as the system models a processor to adapt a blending model that is working with online data running on the processor.

In an embodiment, the system implements SMT metering as a linear operation. The linear operation can utilize a linear model that assists in predicting a single thread performance utilizing a set of performance counters, such as SMT operational parameters and SMT metering counters. In operation, the system collects a set of attributes or a set of counter data via pre- or post-silicon characterization measurements and applies the set to the linear model (see Equation 1). The SMT metering counters are available via hardware (e.g., key attributes: PC₁, PC₂, . . . , for respective model coefficients, a₀, a₁, a₂, . . . ). Again, the key parameters can be chosen by pre-silicon analysis as well as from post-silicon measurements (e.g., Fₙ( )can be constructed from post-silicon/pre-silicon data). The linear model is then multiplied by the SMT performance (see Equation 2). Note that SMTPerformance can be polled by the hardware of the system. Thus, the system can achieve accurate metering by predicting SingleThreadPerformance of the single thread.

Linear Model: Fₙ(x)=a₀+a₁PC₁+a₂PC₂+ . . . Equation 1

SingleThreadPerformance=SMTPerformance* Fₙ(Optional:SMT operation parameters, SMT metering counters) Equation 2

In an embodiment, the SMT metering architecture can choose a linear operation; while in other embodiments the SMT metering architecture can have other forms (e.g., quadratic forms, blended forms, average forms, etc.). Further, in an embodiment, weights and constant values can be set through a post-silicon methodology and are static. The weights/constant values do not need to be changed during an execution time of a program, as well as across different programs. In another embodiment, these weights and constants can be dynamically changed during the execution time of a program.

In an embodiment, results or samples (e.g., metering estimations of a single thread performance) produced by a model can be accumulated as training data by the system. As more results/samples are accumulated, an accuracy of a model can be improved. Note that accuracy can also be small for “corner case” workloads, which are not represented by “training set.”

In another embodiment, the system builds a predictive model that is dynamic in the sense that it can be tuned to fit a running application, a currently executed thread, or a program change. Further, the system allows for firmware implementations, non-firmware implementations, pure hardware implementations, and an implementation that was done purely in a higher level of software than firmware (e.g., the operating system level). That is, other embodiments include, but are not limited to, where the SMT metering model is purely in hardware, such as in a statically-assigned weights/constants case, or with weights/constants adjusted by firmware, or operating system level hardware (e.g. a scheme where hardware takes in counter values, and dynamically adjusts weights, producing a final single-thread estimate, using a neural network or other learning scheme).

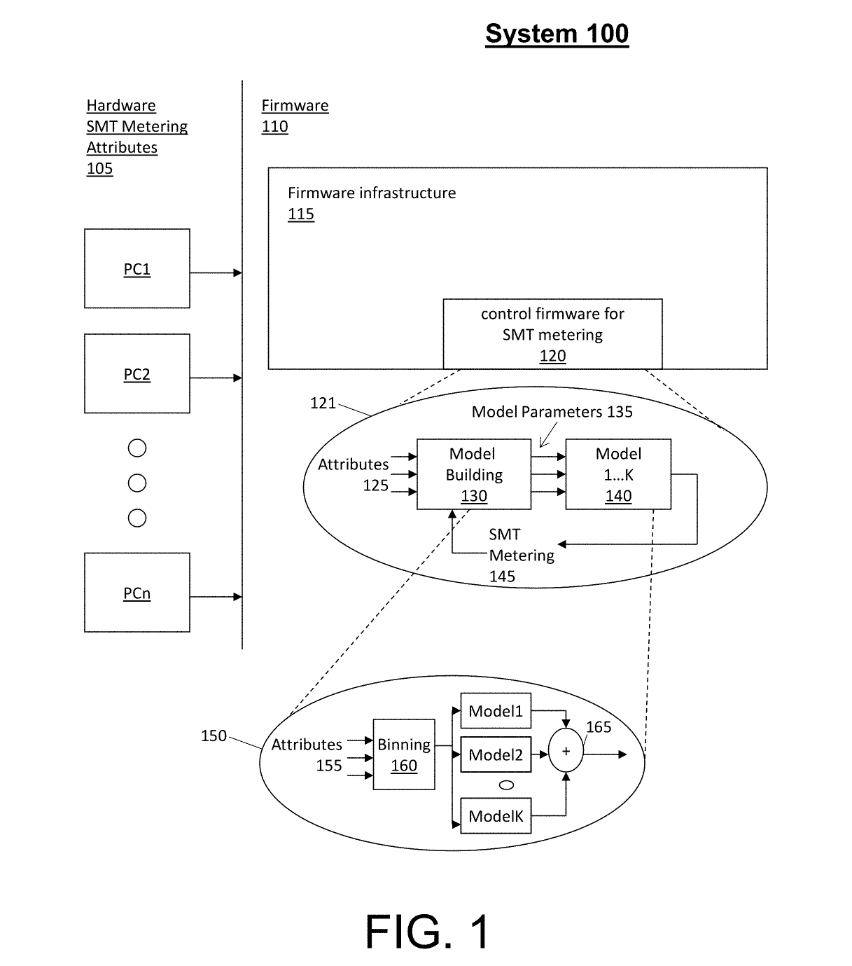

Turning now to FIG. 1, a system 100 is generally shown in accordance with an embodiment. The system 100 includes hardware SMT metering attributes PC₁, PC₂, . . . , PCₙ 105 provided by a processor to a firmware 110. That is, the attributes 105 are a dedicated set of performance counters that go from the hardware level to the firmware level. As these attributes 105 are received by the firmware 110, a firmware infrastructure 115 controls SMT metering 120. Example of the attributes 105 include, but are not limited to, instructions, branch prediction counts (e.g., wrong and correct branch predictions), load store unit issues, fixed point unit issues, total number of flushes, L1 cache accesses, L2 cache accesses, and floating point issues.

The firmware 110, in general, is software in an electronic system or computing device that provides control, monitoring, and data manipulation of engineered products and systems. Typical examples of devices containing firmware are embedded systems, computers, servers, computer peripherals, mobile phones, and digital cameras. The firmware infrastructure 115 is a code portion of the firmware 110. The firmware infrastructure 115 implements SMT metering architecture in the firmware 110. For instance, the firmware infrastructure 115 relies on counter gathering (e.g., attributes 105) from hardware (e.g., the SMT metering function is modeled using attributes PC₁, PC₂, . . . , PCₙ, each of are different attributes corresponding to different micro-architectural events). Further, the firmware infrastructure 115 dynamically adjusts SMT metering measurements through different model building. Thus, the firmware infrastructure 115 manipulates and utilizes the attributes 105, along with builds models (e.g., linear model, quadratic model, etc.) for predicting a single thread performance for any thread being executed in SMT.

The SMT metering 120 is further illustrated in circle 121, where the attributes 125 are utilized during a model building operation 130 to produce model parameters 135. The model parameters 135 are then fed to Models 140 (e.g., Model 1 through Model K), which determine an SMT metering 145. The SMT metering of circle 121 is further illustrated in circle 150, where the attributes 155 are binned 160 according to which model (e.g., Model 1, Model 2, . . . , Model K) they will be applied to or according to which model they fit based on categorization or priority, as further described below. The results of these models are then added 165, where the output of which indicates the SMT metering 145.

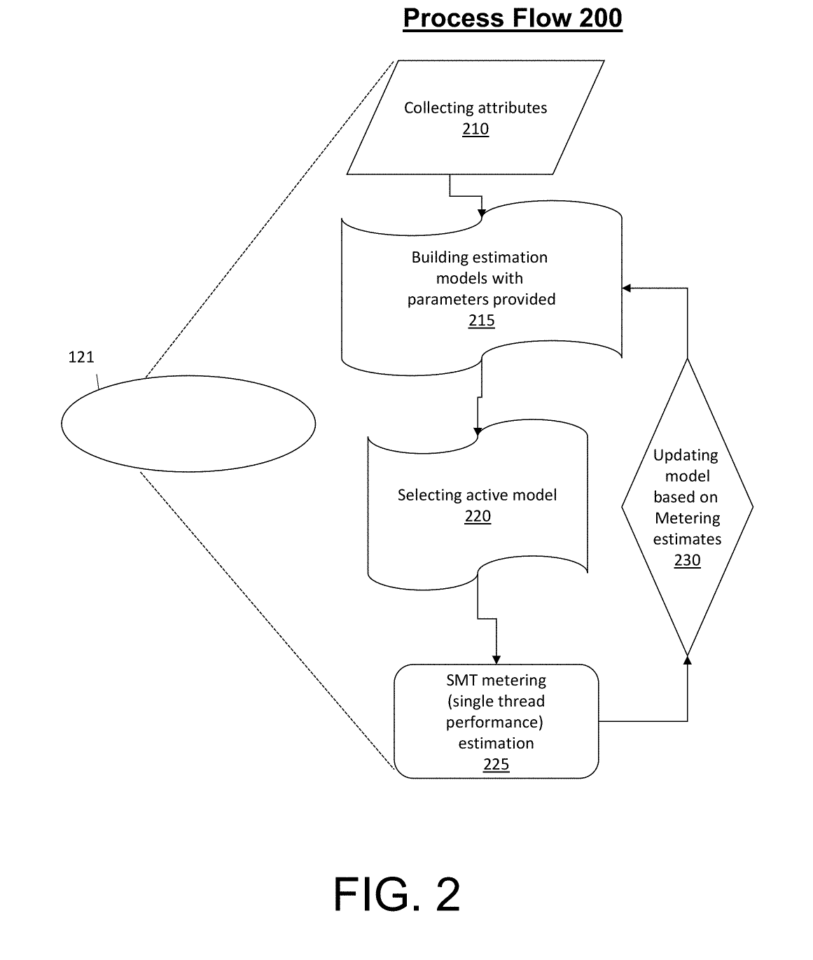

In operation, the SMT metering 120 illustrated in circle 121 can be described with reference to FIG. 2. FIG. 2 illustrates a process flow 200 in accordance with an embodiment. The process flow 200 illustrates a dynamic nature of the firmware 110 of the system 100, by illustrating how the firmware 110 accommodates the attributes 105 corresponding to the performance metrics of the SMT mode. The process flow begins at block 210, where the system 100 collects attributes 105. At block 215, the system 100 builds estimation models with parameters (e.g., the attributes) provided. Further, at block 215, the system 100 can cluster training data and build a multitude of multi-regional models as the estimation models. The estimation models can also be referred to as predictive models. An example of a predictive model is found in Equation 3, where each of a, can be provided via numerical analysis and/or can be programmed during run-time. Another example of a predictive model is found in Equation 3A, where the predictive model uses the SMTPerf as one of the attributes and adds performance factors from the other attributes. Other examples of predictive models are found in Equation 4 and 5.

SingleThreadPerf=SMTPerf*Σ(PCᵢaᵢ) Equation 3

SingleThreadPerf=c*SMTPerf+Σ(PCᵢ*aᵢ) Equation 3A

Model A: SMTPerf*[Σ(PCᵢ*aᵢ)+C] Equation 4

Model B: SMTPerf*[a₁PC₁+a₂ log(PC₂) . . . +α₀] Equation 5

At block 220, the system 100 selects an active model. At block 225, the system 100 uses the selected active model to perform an SMT metering estimation (e.g., of the single thread performance).

At block 230, the system 100 updates the model based on the metering estimates. For example, the system 100 can blend multi-region models to improve accuracy and model coverage (i.e., because some models will perform well on a first data set while other models will perform well on a second data set, a blending of models when both the first and second data sets are encountered can render a high estimation accuracy). The system 100 can also dynamically adapt an SMT metering architecture based on phases of program execution as well as across different program executions. The system 100 can also utilize different models based on the performance feedback from the program (e.g., with key model terms being: a0, a1, . . . ). The system 100 can also construct a training set for improved accuracy and coverage using occurrence probabilities of multiple tasks running on the SMT-enabled processor.

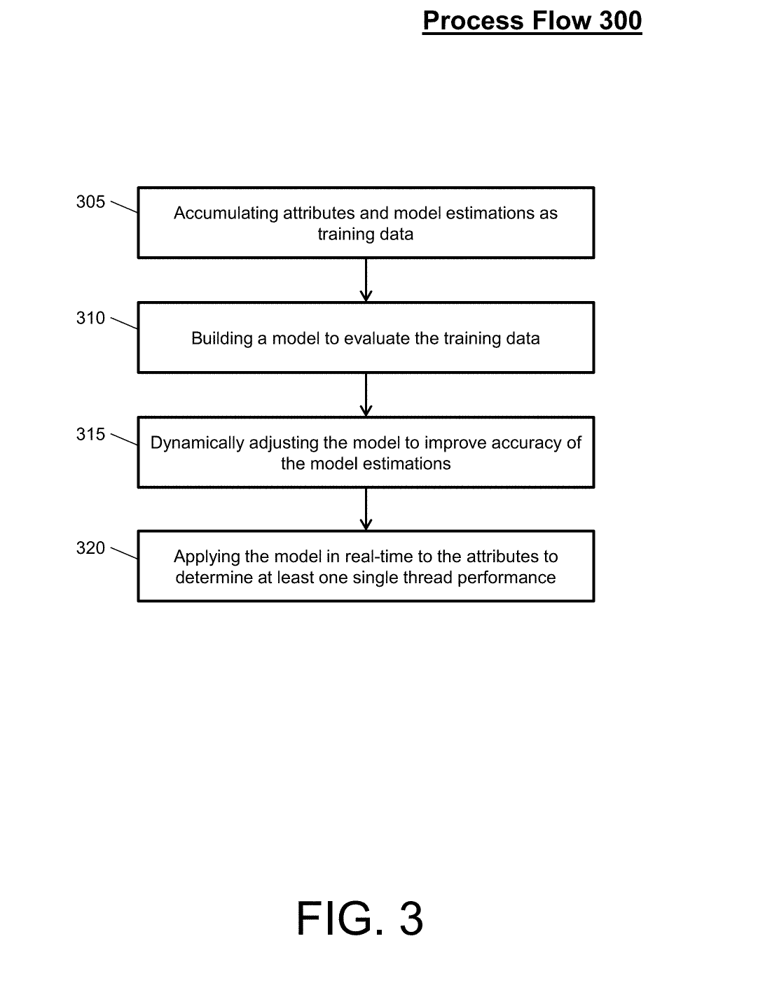

Turning now to FIG. 3, process flow 300 for performing dynamic SMT metering is shown in accordance with an embodiment. The process flow begins at block 305, where the system 100 accumulates attributes and model estimations as training data. At block 310, the system 100 builds a model to evaluate the training data. These ‘training models’ utilize the data collection of block 305 to test various benchmarks. For example, a training model can execute according to Equation 6, where PC={PC1, PC2, . . . , } is a set of performance counters observed as predictive attributes. Further, given cluster PC observations in k clusters via k-means clustering, the training model for each cluster (e.g., clusterⱼ) builds an SMT metering multiplier function Fₙ( ) Furthermore, for each cluster, cluster centroids as knot points and cluster-specific SMT metering function model can be stored in a memory or a disk of the system 100.

Workload_taskᵢ PC₁ PC₂ . . . yₛₘₜ Y₀ Equation 6

At block 315, the system 100 can dynamically adjust the model to improve accuracy of the model estimations. At block 320, the system 100 can apply the model in real-time to the attributes to determine at least one single thread performance. For instance, the system 100 can predict new observations for a new set of PC observations. That is, for each cluster, using the SMT metering function model for the cluster, the system 100 predicts the metering function for the new set of PC observations. Further, the system 100 can calculate blending weights based on inverse proportion of the distance between the new set of PC observations to cluster centroids. Then, the system 100 can blend the predictions using weighting scheme inversely proportional to the distance between the PC observations to the cluster centroids. This approach dynamically/adaptively uses multiple-predictors by improving accuracy of the prediction in multiple regions that displays non-linear behavior that is hard to be modeled as a single global model.

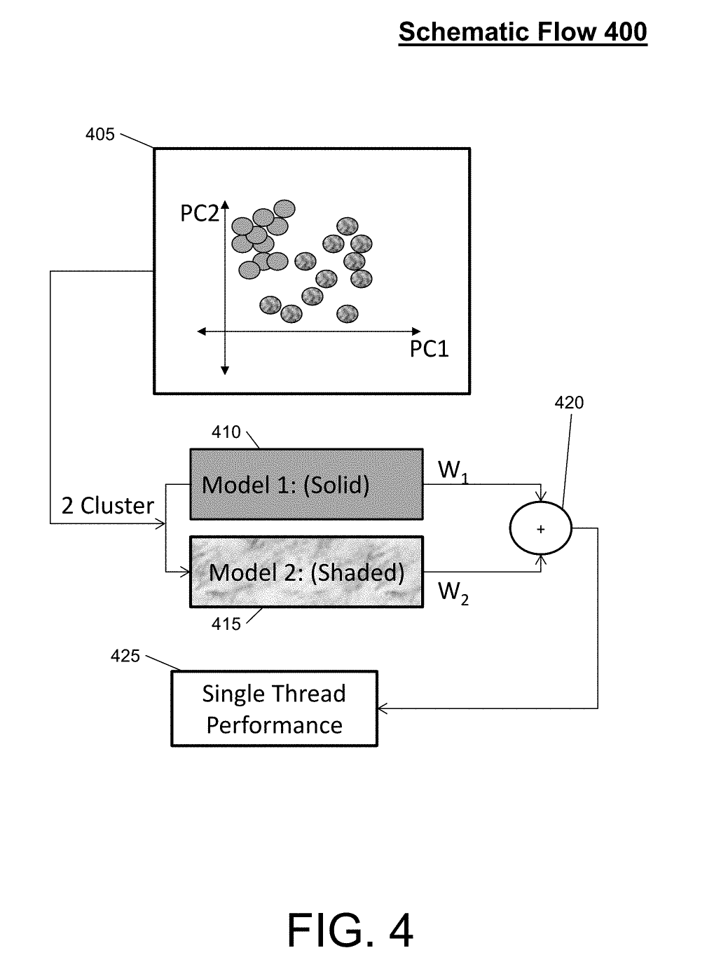

In an embodiment and as indicated above, the system 100 can build a model based on a model blending enhanced for SMT metering. In general, the model blending enhanced for SMT metering focuses on where significant errors happen in the model performance. The model blending enhanced for SMT metering implements an on-the-fly control of model accuracy by monitoring model attributes (e.g., this is achieved building multiple models and blending them on the fly). FIG. 4 illustrates a schematic flow 400 of model blending in accordance with an embodiment. The schematic flow 400 illustrates a pseudo code for model blending.

As shown in block 405 of FIG. 4, data is divided into K-clusters based on PC1, PC2 values. This division, for example, may be done via K-means of pre-silicon/post-silicon measurements. For a cluster k, a model is built for a single thread performance (see Equation 7). Then, for a given PC₁, PC₂ measurement, the system 100 calculates distances to cluster centroids (e.g., d₁, d₂, . . . , d_{K}) and calculates weights for blending models according to Equation 8. For example, each cluster is fed to a respective model (e.g., a first cluster is fed to a Model 1: (Solid) 410 and a second cluster is fed to a Model 2: (Shaded) 415). The weights are normalized by adder 420, according to Equation 9. The adder 420 can also be an operation code configured to calculate an average of the plurality of models. The weights are also blended with the coefficients (e.g., a₀, a₁, . . . , aₖ), according to Equation 10. At block 425, a single thread performance is calculated, according to Equation 11.

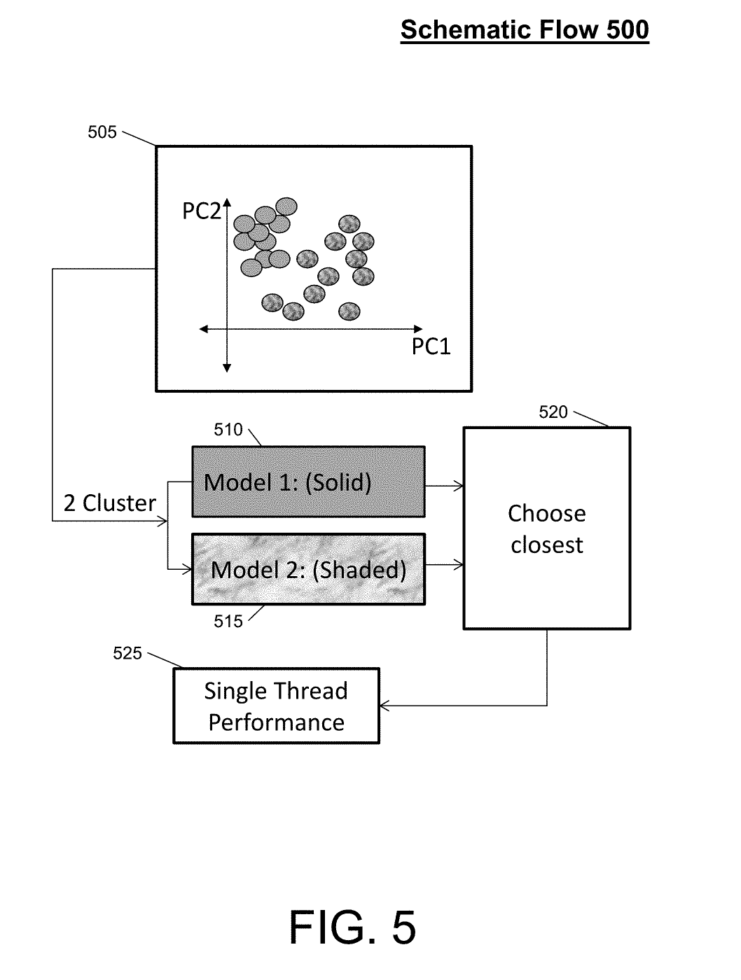

Turning now to FIG. 5, a schematic flow 500 of model blending is illustrated in accordance with an embodiment. The schematic flow 500 illustrates a pseudo code for model blending by choosing a closest model. As shown in block 505 of FIG. 5, data is divided into K-clusters based on PC1, PC2 values. This division, for example, may be done via K-means of pre-silicon/post-silicon measurements. For a cluster k, a model is built for a single thread performance (see Equation 7). Then, for a given PC₁, PC₂ measurement, the system 100 calculates distances to cluster centroids (e.g., d₁, d₂, d_{K}) and find the closest cluster according to Equation 12. For example, each cluster is fed to a respective model (e.g., a first cluster is fed to a Model 1: (Solid) 510 and a second cluster is fed to a Model 2: (Shaded) 515) and a closest cluster is identified at block 520, where the j^{th} cluster model coefficients are used. At block 525, a single thread performance is calculated, according to Equation 7.

SingleThreadPerformance=yₛₘₜ*(a_{0,k}+a_{1,k}PC₁+ . . . ) Equation 7

w₁=1−d₁/mean(d) Equation 8

w₁+w₂+ . . . +wₖ=1 Equation 9

a₀=w₁a_{0,1}+w₂a_{0.2} . . . Equation 10

SingleThreadPerformance=ₛₘₜ*(a₀+a₁PC₁+ . . . ) Equation 11

argmin(d)=j^{th} cluster Equation 12

SingleThreadPerformance=yₛₘₜ*(a_{0,j}+a_{1,j}PC₁+ . . . ) Equation 13

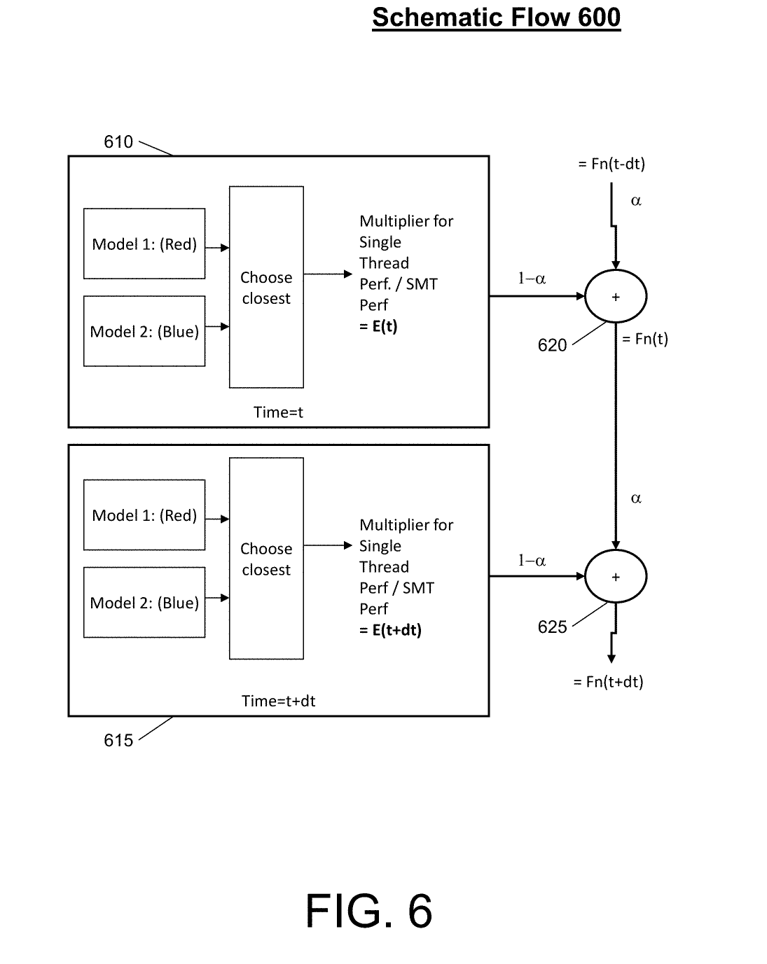

Turning now to FIG. 6, a schematic flow 600 of dynamic SMT adjustments is illustrated in accordance with an embodiment. In general, the schematic flow 600, at block 610 and 615, implements a model blending while a closest cluster model sets up model coefficients from known model dictionary. The schematic flow 600 uses the closest cluster technique to select the proper predictive model for SingleThreadPerformance/SMTPerf. Further, the schematic flow 600 does not use the model directly and it smoothes the estimate E( ) based on moving smoothed averaging with parameter alpha. Note alpha (‘a’) is used as a weighting between the previous-time value and the current time-step model input. The smoothing makes more stable and less volatile estimates on the SingleThreadPerformance/SMTPerf ratio.

For the model blending, the system 100 adaptively adjusts based on distances to cluster centroids. The dynamic adjustment requires that the multiple models for SingleThreadPerf/SMTPerf for each cluster (e.g., in Model Blending) and also memory for previous estimates to perform smoothing on the data. For the closest cluster model, the system 100 picks a useful cluster model. Moreover, the system 100 can dynamically adjust SMT metering function using a smoother to filter high-frequency noise in data and estimates (e.g., see Equations 14 and 15 with respect to adders 620 and 625, where E_{t+dt} is the multiplier from the SMT metering model using PC's for time=t+dt).

time=t,SingleThreadPerf=SMTPerf*Aₜ Equation 14

time=t+dt,SingleThreadPerf=SMTPerf*(aAₜ+(1−a)E_{t+dt}) Equation 15

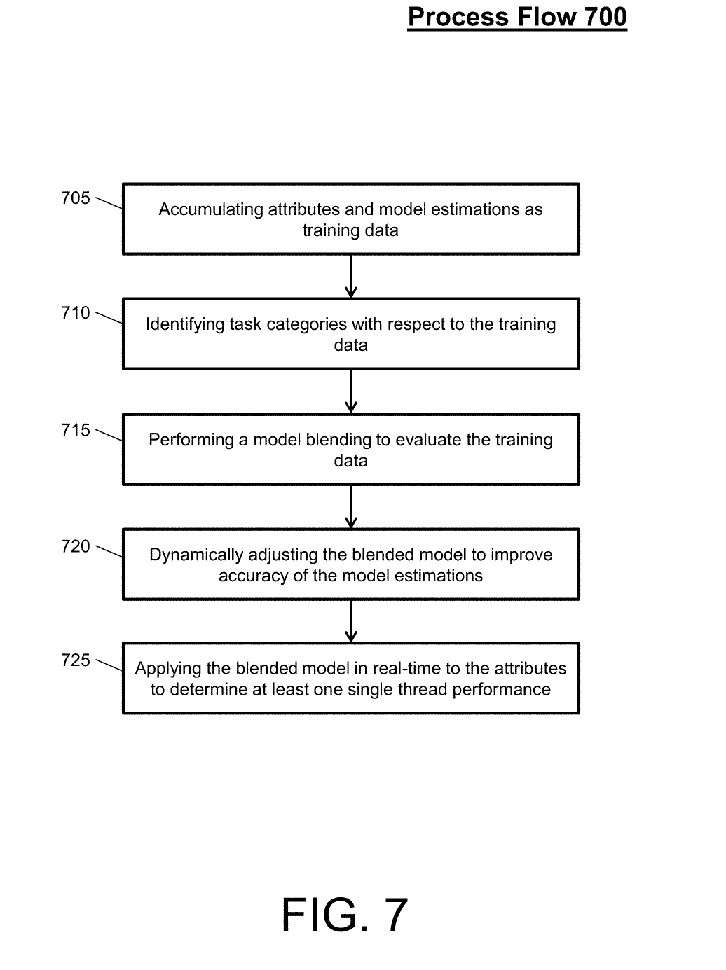

Turning now to FIG. 7, a process flow 700 for performing dynamic simultaneous multithreading metering is illustrated in accordance with an embodiment. The schematic flow 500, for instance, illustrates extending model blending for task categories. In this way, the process flow 700 implements creating multiple models representing different task categories jointly running on the system and selecting/blending the proper model in real-life operation. Further, the process flow 700 can be provided for modeling for distinct workloads/tasks.

The process flow 700 begins at block 705, where the system 100 accumulates attributes and model estimations as training data. At block 710 the system 100 identifies task categories with respect to the training data. That is, on a given SMT enabled machine, many tasks run at the same time. Task categories are known to a designer/user. Examples of categories include, but are not limited to (as it is extendable by the designer/user), Task-A: High CPU utilization tasks; Task-B: Medium CPU utilization tasks; and Task-C: Low CPU utilization tasks. Any given time a set of tasks (4 for SMT4) may be running on the processor from these task categories. The data collected for training SMT Metering functions can be assigned a task identification (e.g., TaskID PC1 PC2 . . . yₛₘₜ y₀). The TaskID can be the words encoded from the task categories. For example: A, B, C, AB, AC, AB, AA, BB, ABC, ABCB, AAA etc.

At block 715, the system 100 performs a model blending to evaluate the training data. That is, the system 100 can extend the blending models based on a larger set of ExtendedPC={TaskID, PC1, PC2, . . . }. For each TaskID, a blended model can be generated, and used for prediction. Otherwise, in the case that a blended model is not used on TaskID, the system 100 can encode TaskID to a binary vector and use it to build clusters as in set of PC attributes (e.g., TaskID can be used to cluster the PCi, such as clustering the PCi for the same task). The TaskID can also be useful in accurately generating and building training dataset for accurate characterization.

At block 720, the system 100 can dynamically adjust the blended model to improve accuracy of the model estimations. At block 725, the system 100 can apply the blended model in real-time to the attributes to determine at least one single thread performance.

In view of the above, an example implementation will now be discussed with respect to when observation data is divided into k clusters based on attribute values. In this case, the observation data can be arranged in terms of a matrix, where each column represents an attribute that is observed as a measurement (e.g., counters of misses, hits, or some event count that is available) related to performance of the SMT of the system 100. That is, the column represents observations a firmware 110 can make using the system 100 counters and/or parameters. Using a model (e.g., linear, quadratic, etc.), the system can calculate estimates. Amongst the estimates, the system 100 observes clusters or multiple-regions in high dimensional attribute space in which the model parameters changes. For example, in a first corner of the attribute space, the corresponding values can be low. Further, in a second corner of the attribute space, the corresponding values can be high. Further, due to the change across the attribute space, different models may be chosen and/or blended, That is, based on observed clustering, a linear model may be a best fit for the first corner of the attribute space, while a quadratic model may be a best fit for the second corner of the attribute space.

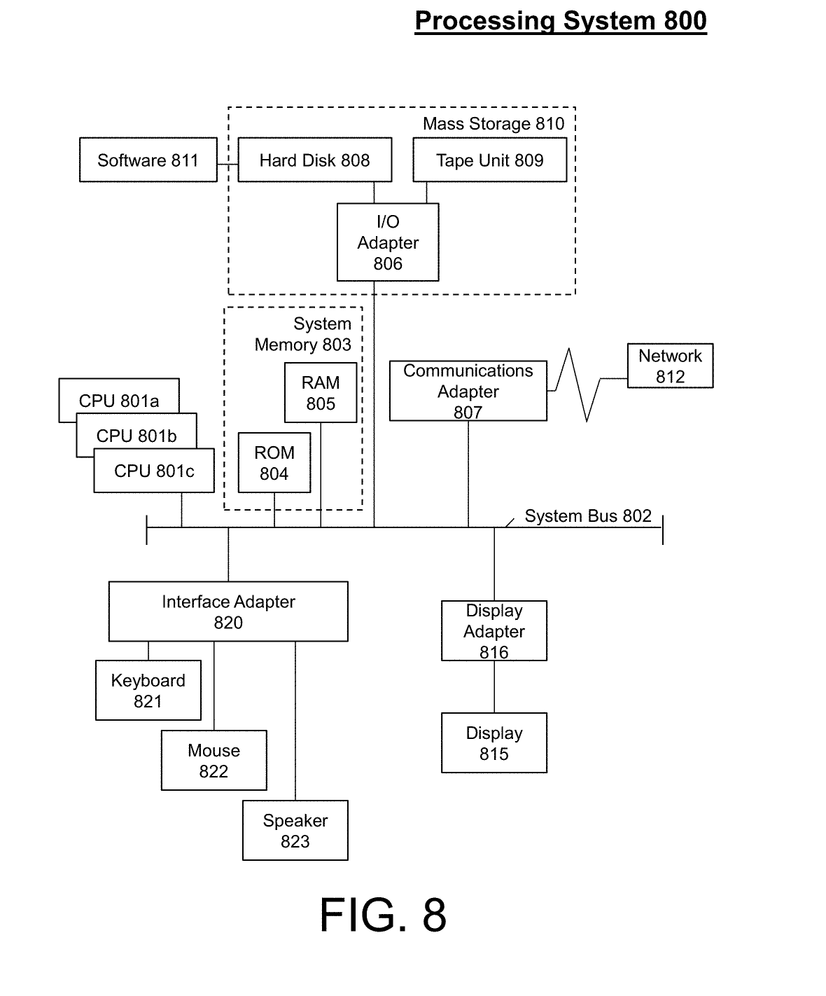

Referring now to FIG. 8, there is shown an embodiment of a processing system 800 for implementing the teachings herein. In this embodiment, the processing system 800 has one or more central processing units (processors) 801a, 801b, 801c, etc. (collectively or generically referred to as processor(s) 801). The processors 801, also referred to as processing circuits, are coupled via a system bus 802 to system memory 803 and various other components. The system memory 803 can include read only memory (ROM) 804 and random access memory (RAM) 805. The ROM 804 is coupled to system bus 802 and may include a basic input/output system (BIOS), which controls certain basic functions of the processing system 800. RAM is read-write memory coupled to system bus 802 for use by processors 801.

FIG. 8 further depicts an input/output (I/O) adapter 806 and a network adapter 807 coupled to the system bus 802. I/O adapter 806 may be a small computer system interface (SCSI) adapter that communicates with a hard disk 808 and/or tape storage drive 809 or any other similar component. I/O adapter 806, hard disk 808, and tape storage drive 809 are collectively referred to herein as mass storage 810. Software 811 for execution on processing system 800 may be stored in mass storage 810. The mass storage 810 is an example of a tangible storage medium readable by the processors 801, where the software 811 is stored as instructions for execution by the processors 801 to perform a method, such as the process flows of the above FIGS. Network adapter 807 interconnects system bus 802 with an outside network 812 enabling processing system 800 to communicate with other such systems. A screen (e.g., a display monitor) 815 is connected to system bus 802 by display adapter 816, which may include a graphics controller to improve the performance of graphics intensive applications and a video controller. In one embodiment, adapters 806, 807, and 816 may be connected to one or more I/O buses that are connected to system bus 802 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 802 via an interface adapter 820 and the display adapter 816. A keyboard 821, mouse 822, and speaker 823 can be interconnected to system bus 802 via interface adapter 820, which may include, for example, a Super I/O chip integrating multiple device adapters into a single integrated circuit.

Thus, as configured in FIG. 8, processing system 805 includes processing capability in the form of processors 801, and, storage capability including system memory 803 and mass storage 810, input means such as keyboard 821 and mouse 822, and output capability including speaker 823 and display 815. In one embodiment, a portion of system memory 803 and mass storage 810 collectively store an operating system, such as the z/OS or AIX operating system from IBM Corporation, to coordinate the functions of the various components shown in FIG. 8.

Technical effects and benefits include building a predictive model for single thread, clustering of training data, building a multitude of multi-regional models, and blending multi-regional models to improve accuracy and model coverage. Thus, embodiments described herein are necessarily rooted in a firmware of a system to perform proactive operations to overcome problems specifically arising in the realm of SMT.

Embodiments herein may be a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments herein.

Aspects of the embodiments herein are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1-8. (canceled)

9. A computer program product, the computer program product comprising a computer readable storage medium having program instructions for dynamic simultaneous multithreading metering for a plurality of independent threads being multithreaded embodied therewith, the program instructions executable by a processor to cause:
collecting attributes from processor;
building a model utilizing the attributes;
performing the dynamic simultaneous multithreading metering in accordance with the model to output metering estimates for a first thread of the plurality of independent threads being multithreaded; and
updating the model based on the metering estimates.

10. The computer program product of claim 9, wherein the building of the model comprises a blending of multiple predictors to achieve accuracy for the metering estimates for the first thread.

11. The computer program product of claim 9, wherein the model is one of a plurality of models utilized during the performing of the dynamic simultaneous multithreading metering, and
wherein the dynamic simultaneous multithreading metering is a calculated average of the plurality of models.

12. The computer program product of claim 9, wherein the model is a linear model.

13. The computer program product of claim 9, wherein the dynamic simultaneous multithreading metering is dynamically adjusted using a smoother to filter high-frequency noise in the attributes and the metering estimates.

14. The computer program product of claim 9, wherein the collecting of the attributes comprises accumulating the attributes and the metering estimates as training data.

15. The computer program product of claim 14, further comprising identifying task categories with respect to the training data.

16. The computer program product of claim 9, wherein the metering estimates for the first thread of the plurality of independent threads is a single thread performance prediction in a simultaneous multithreading setting.

17. A system, comprising a processor and a memory storing program instructions for dynamic simultaneous multithreading metering for a plurality of independent threads being multithreaded thereon, the program instructions executable by a processor to cause:
collecting attributes from processor;
building a model utilizing the attributes;
performing the dynamic simultaneous multithreading metering in accordance with the model to output metering estimates for a first thread of the plurality of independent threads being multithreaded; and
updating the model based on the metering estimates.

18. The system of claim 17, wherein the building of the model comprises a blending of multiple predictors to achieve accuracy for the metering estimates for the first thread.

19. The system of claim 17, wherein the model is one of a plurality of models utilized during the performing of the dynamic simultaneous multithreading metering, and
wherein the dynamic simultaneous multithreading metering is a calculated average of the plurality of models.

20. The system of claim 17, wherein the model is a linear model.
